(19) United States
(12) Patent Application Publication
(10) Pub. No.: US 2026/0024680 A1
(43) Pub. Date: Jan. 22, 2026

(54) CABLE

(71) Applicant: SUMITOMO ELECTRIC INDUSTRIES, LTD., Osaka (JP)

(72) Inventors: Kenji HORI, Tochigi (JP); Yutaka MATSUMURA, Osaka (JP); Hitoshi ENDO, Tochigi (JP); Takumi OOSHIMA, Tochigi (JP); Takashi YABE, Tochigi (JP)

(21) Appl. No.: 19/232,102

(22) Filed: Jun. 9, 2025

(30) Foreign Application Priority Data
Jul. 18, 2024 (JP) 2024-115062

(51) Int. Cl. H01B 11/10; H01B 1/02; H01B 3/44; H01B 7/00; H01B 7/295

(52) U.S. Cl. CPC H01B 11/10; H01B 1/023; H01B 3/443; H01B 7/0009; H01B 7/295

(57) ABSTRACT

A cable includes a core including at least one covered electric wire, and an outer sheath disposed outside the core. The at least one covered electric wire includes a conductor made of a copper alloy and an insulator disposed outside the conductor. The conductor is a twisted wire formed by twisting a plurality of conductor element wires together, and a twist pitch of the conductor is less than or equal to 25 times an outer diameter of the conductor. The insulator contains a polyvinyl chloride resin and has a tensile modulus of 150 MPa or more.

### CROSS REFERENCE TO RELATED APPLICATIONS

This application claims priority to Japanese Patent Application No. 2024-115062 filed on Jul. 18, 2024, and the entire contents of the Japanese patent application are incorporated herein by reference.

### TECHNICAL FIELD

The present disclosure relates to cables.

### BACKGROUND

Patent literature (Japanese Unexamined Patent Application Publication No. 2022-113276) discloses a multi-core cable including a plurality of twisted insulated wires each having a conductor and an insulating layer covering an outer periphery of the conductor, and a plurality of fillers in contact with the insulating layers of the plurality of insulated wires. A lubricant is applied to each of the plurality of fillers. An absolute value of a difference between an SP value of a material forming the plurality of fillers and an SP value of the lubricant is smaller than an absolute value of a difference between the SP value of the lubricant and an SP value of a material forming the insulating layer.

### SUMMARY

A cable of the present disclosure includes a core including at least one covered electric wire, and an outer sheath disposed outside the core. The at least one covered electric wire includes a conductor made of a copper alloy and an insulator disposed outside the conductor. The conductor is a twisted wire formed by twisting a plurality of conductor element wires together, and a twist pitch of the conductor is less than or equal to 25 times an outer diameter of the conductor. The insulator contains a polyvinyl chloride resin and has a tensile modulus of 150 MPa or more.

### BRIEF DESCRIPTION OF THE DRAWINGS

FIG. 1 is a cross-sectional view in a plane perpendicular to the longitudinal direction of a cable according to an embodiment of the present disclosure.

FIG. 2 is a cross-sectional view in a plane perpendicular to the longitudinal direction of a cable according to another embodiment of the present disclosure.

FIG. 3 is a cross-sectional view in a plane perpendicular to the longitudinal direction of a cable according to another embodiment of the present disclosure.

FIG. 4 is a cross-sectional view in a plane perpendicular to the longitudinal direction of a cable according to another embodiment of the present disclosure.

FIG. 5 is an explanatory view of a method for evaluating bending resistance.

FIG. 6 is a table showing the configuration and evaluation results of experiments.

### DETAILED DESCRIPTION

Cables used in factories or the like are disposed in driving units or the like and may be repeatedly bent. Thus, cables used in factories and the like are required to have bending resistance.

Thus, an object of the present disclosure is to provide a cable having bending resistance.

Embodiments will be described below.

First, embodiments of the present disclosure will be listed and described. In the following description, the same or corresponding elements are denoted by the same reference numerals, and the same description thereof will not be repeated.
(1) A cable according to an aspect of the present disclosure includes a core including at least one covered electric wire, and an outer sheath disposed outside the core. The at least one covered electric wire includes a conductor made of a copper alloy and an insulator disposed outside the conductor. The conductor is a twisted wire formed by twisting a plurality of conductor element wires together, and a twist pitch of the conductor is less than or equal to 25 times an outer diameter of the conductor. The insulator contains a polyvinyl chloride resin and has a tensile modulus of 150 MPa or more.

The conductor of the covered electric wire included in the cable according to an aspect of the present disclosure is made of a copper alloy, and thus the conductor has higher strength and is less likely to be broken, as compared with the case where the conductor is made of annealed copper.

By setting the twist pitch of the conductor to be less than or equal to 25 times the outer diameter of the conductor, it is possible to stabilize the behavior of the cable in which the position of the covered electric wire changes when the cable is bent, and a large load can be suppressed from being locally applied to the conductor.

Since the insulator contains the polyvinyl chloride resin, the tensile modulus of the insulator can be easily set within a desired range. By setting the tensile modulus of the insulator to 150 MPa or more, it is possible to stabilize the behavior of the cable in which the position of the covered electric wire changes when the cable is bent, and a large load can be suppressed from being locally applied to the conductor.

Thus, according to the cable according to an aspect of the present disclosure, even when the cable is repeatedly bent, the conductor included in the covered electric wire of the cable can be suppressed from being broken, and thus the bending resistance of the cable can be increased.
(2) In the above (1), the core may include a plurality of the covered electric wires. The plurality of covered electric wires may be twisted together along a longitudinal direction of the plurality of covered electric wires.

Since the core includes the plurality of covered electric wires, a plurality of terminals can be connected by one cable, and workability of wiring can be improved.

Since the plurality of covered electric wires are twisted together, the plurality of covered electric wires can be handled as an integrated object, and thus the productivity of the cable can be increased, and the adhesion to the outer sheath can also be increased.
(3) In the above (1) or (2), the cable may further include a shield layer disposed between the core and the outer sheath.

Since the cable includes the shield layer, it is possible to reduce signal leakage to the outside and signal intrusion from the outside. The shield layer can also mechanically protect the core.
(4) In any one of the above (1) to (3), the copper alloy may be a copper-tin alloy.

By using a copper-tin alloy as the copper alloy of the conductor, electrical conductivity can be increased and the cost can be reduced.
(5) In any one of the above (1) to (4), the outer sheath may contain a polyvinyl chloride resin. The polyvinyl chloride resin is a resin having excellent flame retardancy. Thus, the flame retardancy of the cable can be increased by the outer sheath containing the polyvinyl chloride resin.
(6) In any one of the above (1) to (5), the outer sheath may contain a flame retardant.

The flame retardancy of the cable can be increased by the outer sheath containing the flame retardant.
(7) In any one of the above (1) to (6), the core may include a twisted-pair electric wire formed of two covered electric wires twisted together, each of the two covered electric wires being the at least one covered electric wire.

By twisting two covered electric wires together to form a twisted-pair electric wire, it is possible to make a signal transmitted by the covered electric wire less susceptible to noise.
(8) In any one of the above (1) to (7), the core may include a filler.

Since the core includes the filler, the position of the covered electric wire included in the cable can be suppressed from being displaced when the cable is repeatedly bent, and thus the bending resistance can be increased. In addition, in a cross section perpendicular to the longitudinal direction of the cable, the shape of the contour line of the core can be made close to a circle, and the handleability of the cable can be improved.

### Details of Embodiments of Present Disclosure

A specific example of a cable according to one embodiment of the present disclosure (hereinafter, referred to as “the present embodiment”) will be described below with reference to the drawings. The present invention is not limited to these examples, but is defined by the scope of the claims, and is intended to include all modifications within the meaning and scope equivalent to the scope of the claims.

### Cable

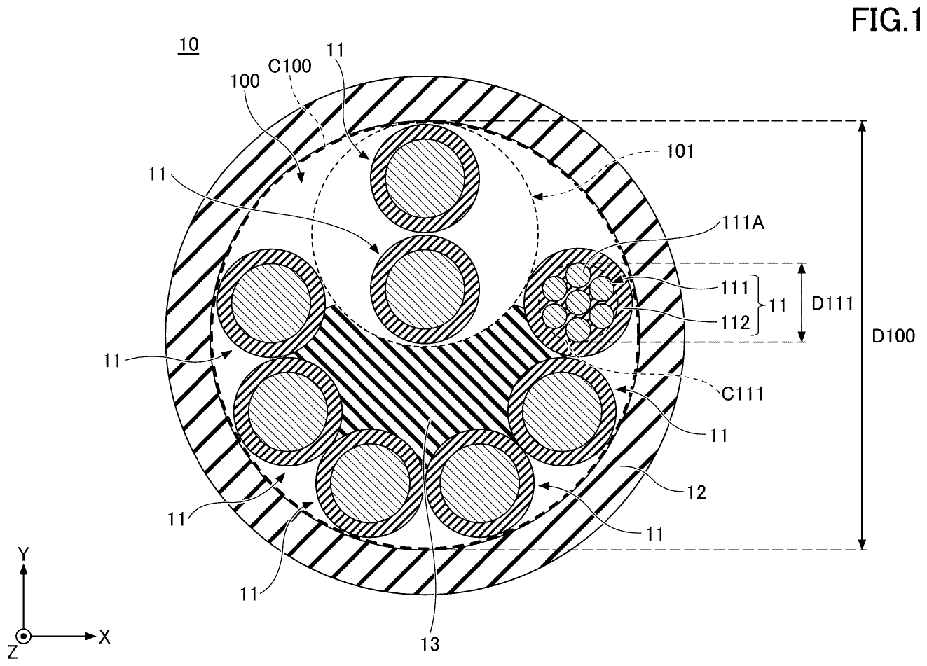

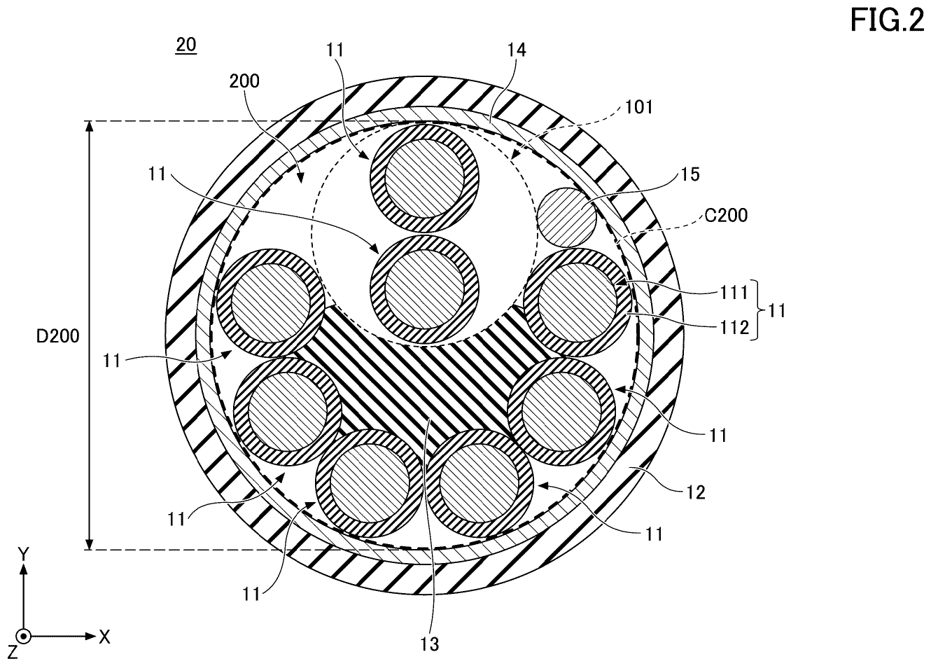

FIG. 1 shows a schematic view in a cross section perpendicular to the longitudinal direction of a cable of the present embodiment. Each of FIGS. 2, 3, and 4 shows a schematic view in a cross section perpendicular to the longitudinal direction of a cable according to other configuration examples of the present embodiment. In each of FIGS. 1, 2, 3 and 4, the longitudinal direction of the cable is along the Z-axis, i.e., the axis perpendicular to the plane of the paper. Each of FIGS. 1, 2, 3, and 4 shows a cross section in the XY plane perpendicular to the Z axis.

Since FIGS. 2, 3, and 4 are explanatory views of other configuration examples of the cable of the present embodiment, the description will be made mainly using FIG. 1, and the description will be made using FIGS. 2, 3, and 4 as necessary.

As shown in FIG. 1, a cable 10 of the present embodiment includes a core 100 including a covered electric wire 11 and an outer sheath 12 disposed outside the core 100.

### (1) Each Member Included in Cable

Each member included in the cable of the present embodiment will be described.

### (1-1) Core

As shown in FIG. 1, the core 100 may include the covered electric wire 11.

The number of the covered electric wires 11 included in the core 100 is not particularly limited.

The core may include only one covered electric wire 11. Further, the core 100 may include two or more covered electric wires 11, as in the covered electric wires 11 shown in FIG. 1. When the core 100 includes the plurality of covered electric wires 11, the cable 10 of the present embodiment may be indicated as a multi-core cable.

Since the core 100 includes the plurality of covered electric wires 11, a plurality of terminals can be connected by one cable, and workability of wiring can be improved.

When the core 100 includes the plurality of covered electric wires 11, the plurality of covered electric wires 11 may be twisted together along the longitudinal direction thereof. Since the plurality of covered electric wires 11 are twisted together, the plurality of covered electric wires 11 can be handled as an integrated object, and thus the productivity of the cable 10 can be increased, and the adhesion to the outer sheath 12 can also be increased.

The twist pitch of the core 100, that is, the twist pitch when the covered electric wires 11 included in the core 100 are twisted together is not particularly limited. The twist pitch of the core 100 may be, for example, 5 times to 20 times an outer diameter D100 of the core 100.

By setting the twist pitch of the core 100 to be less than or equal to 20 times the outer diameter D100 of the core 100, even when the cable 10 is repeatedly bent, the position of the covered electric wire 11 included in the core 100 is less likely to change, and the bending resistance can be increased.

By setting the twist pitch of the core 100 to be greater than or equal to 5 times the outer diameter D100 of the core 100, the productivity of the core 100 and the cable can be increased.

The outer diameter D100 of the core 100 can be an average value of lengths of two orthogonal diameters in a minimum enclosing circle C100 of the core 100. In this specification, the bending resistance means a characteristic that the covered electric wire 11 included in the cable 10 is not easily broken when the cable 10 is repeatedly bent.

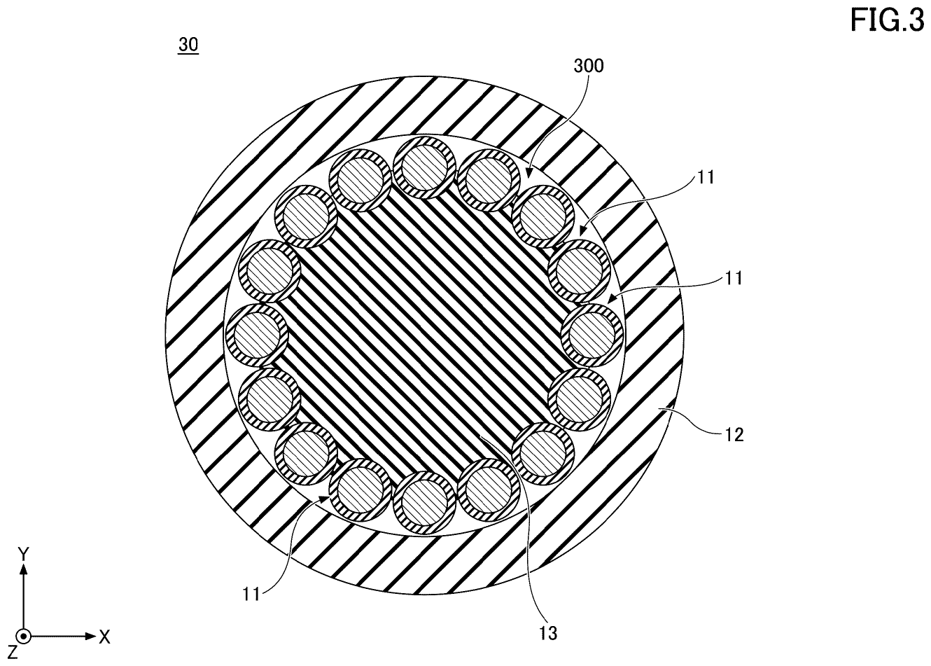

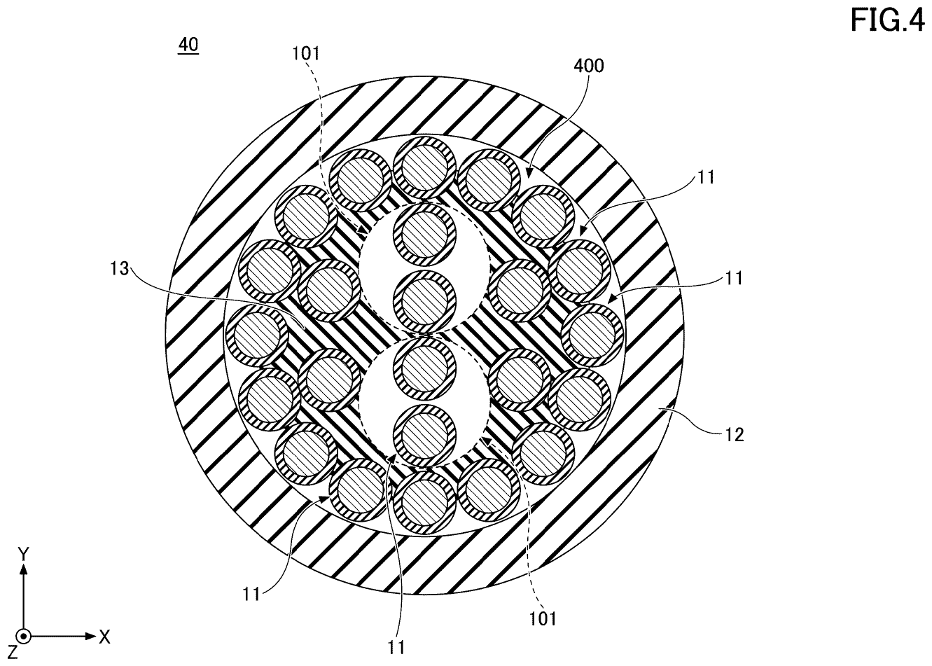

Although FIG. 1 shows an example in which the core 100 includes eight covered electric wires 11, the present disclosure is not limited to such a configuration. For example, a core 300 may include 16 covered electric wires 11 as in a cable 30 shown in FIG. 3, and a core 400 may include 24 covered electric wires 11 as in a cable 40 shown in FIG. 4. However, the cable of the present embodiment is not limited to the configurations of the cables shown in FIGS. 1, 3, and 4, and the cable of the present embodiment can include any number of covered electric wires 11 according to the use or the like. In addition, the covered electric wires 11 included in the cable of the present embodiment are not limited to the case where the conductor and the insulator have the same size and are made of the same material, and may include covered electric wires 11 having different sizes and made of different materials.

In FIGS. 3 and 4, although the reference numerals of some of the covered electric wires 11 and the reference numerals of a conductor 111 and an insulator 112 forming the covered electric wire 11 are omitted, but objects having the same double-circle shape in the drawings are the covered electric wires 11. As will be described with reference to FIG. 1, each covered electric wire 11 includes the conductor 111 and the insulator 112.

As shown in FIG. 1, the core 100 may include a twisted-pair electric wire 101 formed by twisting two covered electric wires 11 together. For example, as shown in FIG. 4, the core 400 may include a plurality of pairs of the twisted-pair electric wires 101. Some of the covered electric wires 11 included in the core 100 may be twisted-pair electric wires, or all of the covered electric wires 11 may be twisted-pair electric wires.

The twisted-pair electric wire 101 may be further twisted with another covered electric wire 11 or another twisted-pair electric wire 101 to form the core 100.

By twisting two covered electric wires together to form a twisted-pair electric wire, it is possible to make a signal transmitted by the covered electric wire less susceptible to noise.

### (1-2) Covered Electric Wire

The covered electric wire 11 includes the conductor 111 made of a copper alloy and the insulator 112 disposed outside the conductor 111.

### (1-2-1) Conductor

The inventors of the present invention have studied a cable having excellent bending resistance. As a result, the inventors have found that the conductor 111 made of a copper alloy allows the bending resistance to be increased. This is because the conductor 111 made of a copper alloy allows the strength of the conductor 111 to be increased and thus the conductor is less likely to be broken, as compared with the case where the conductor is made of annealed copper.

Examples of the copper alloy used for the conductor 111 include one or more kinds selected from a copper-silver alloy, a copper-tin alloy, a copper-zirconium alloy, and a copper-beryllium alloy. The copper alloy used for the conductor 111 may be a copper-tin alloy. By using a copper-tin alloy as the copper alloy of the conductor 111, electrical conductivity can be increased and cost can be reduced.

The content of tin in the copper-tin alloy is not particularly limited, but the copper-tin alloy may contain tin at a ratio of 0.1 mass % to 1.7 mass %, for example. The copper-tin alloy contains tin at a ratio of 0.1 mass % or more, and thus it is possible to increase the strength of the conductor 111. In addition, the copper-tin alloy contains tin at a ratio of 1.7 mass % or less, and thus it is possible to increase the electrical conductivity of the conductor 111.

The conductor 111 may be a twisted wire formed by twisting a plurality of conductor element wires 111A together. Although the conductor element wire 111A are shown only in the conductor 111 included in one covered electric wire 11, the conductor may be a twisted wire formed by twisting conductor element wires together even in the covered electric wire 11 in which the conductor is shown by one circle. The same applies to the cables shown in FIGS. 2 to 4.

The twist pitch of the conductor 111, that is, the twist pitch when the conductor element wires 111A are twisted together, may be less than or equal to 25 times an outer diameter D111 of the conductor 111, and may be less than or equal to 18 times the outer diameter D111 of the conductor 111.

By setting the twist pitch of the conductor 111 to be less than or equal to 25 times the outer diameter D111 of the conductor 111, it is possible to stabilize the behavior of the cable 10 in which the position of the covered electric wire 11 changes when the cable 10 is bent. Thus, a large load can be suppressed from being locally applied to the conductor 111.

The lower limit of the twist pitch of the conductor 111 is not particularly limited, and may be, for example, greater than or equal to 10 times the outer diameter D111 of the conductor 111, or greater than or equal to 15 times the outer diameter D111 of the conductor 111.

The twist pitch of the conductor 111 may be, for example, 10 times to 25 times, or 15 times to 18 times the outer diameter D111 of the conductor 111.

The cross-sectional area of the conductor 111 is not particularly limited, but may be, for example, 0.05mm² to 3 mm².

By setting the cross-sectional area of the conductor 111 to be 0.05 mm² or more, the electric resistance value of the conductor can be reduced. By setting the cross-sectional area of the conductor 111 to be 3 mm² or less, the covered electric wire 11 can be reduced in weight.

The cross-sectional area of the conductor 111 is obtained by multiplying the cross-sectional area of the conductor element wire 111A, which is obtained from the element wire diameter of the conductor element wire 111A, by the number of conductor element wires 111A included in the conductor 111.

### (1-2-2) Insulator

The insulator 112 can cover the outer surface of the conductor 111, specifically, the outer surface of the covered electric wire 11 along the longitudinal direction, as shown in FIG. 1.

### (Component Contained in Insulator)

### The insulator 112 may contain a resin.

The insulator 112 may contain a polyvinyl chloride resin. Since the insulator 112 contains the polyvinyl chloride resin, the tensile modulus of the insulator 112 can be easily set within a desired range.

The resin may be crosslinked or not crosslinked.

The insulator 112 may contain one or more kinds of additives selected from a flame retardant, a flame retardant aid, an antioxidant, a lubricant, a coloring agent, a reflection-imparting agent, a masking agent, a processing stabilizer, and a plasticizer, in addition to the resin.

As will be described later, the tensile modulus of the insulator 112 may be 150 MPa or more.

In order to set the tensile modulus of the insulator 112 to 150 MPa or more, the insulator 112 may contain additives, for example, the plasticizer. As the plasticizer, a plasticizer which can be used for polyvinyl chloride included in the insulator 112 can be used. As the plasticizer, for example, one or more kinds selected from phthalate ester plasticizers such as diisononyl phthalate (DINP) and dioctyl phthalate (DOP), trimellitate ester plasticizers such as tris (2-ethylhexyl) trimellitate (TOTM), polyester plasticizers, and the like can be used.

The content of the plasticizer in the insulator 112 is not particularly limited, and can be selected according to the type of the plasticizer so that the tensile modulus of the insulator 112 has a desired value.

### (Tensile Modulus of Insulator)

The tensile modulus of the insulator 112 may be 150 MPa or more.

By setting the tensile modulus of the insulator 112 to 150 MPa or more, it is possible to stabilize the behavior in which the position of the covered electric wire 11 changes when the cable 10 is bent. That is, when the cable 10 is repeatedly bent, the change in the position of the covered electric wire 11 does not become irregular, but can be made smaller regularly. Thus, when the cable 10 is bent, a large load can be suppressed from being locally applied to the conductor 111.

The upper limit of the tensile modulus of the insulator 112 is not particularly limited, but may be, for example, 600 MPa or less. Thus, the tensile modulus of the insulator 112 may be 150 MPa to 600 MPa.

The tensile modulus of the insulator 112 can be adjusted by, for example, the mixing ratio of the plasticizer contained in the insulator 112.

### (1-3) Outer Sheath

As shown in FIG. 1, the cable 10 may further include the outer sheath 12 disposed outside the core 100.

The cable 10 includes the outer sheath 12, and thus the covered electric wire 11 included in the core 100 disposed inside is protected, and durability is enhanced.

### (Resin)

The outer sheath 12 may include a resin. The resin is not particularly limited, but the outer sheath 12 may contain, for example, one or more kinds selected from a polyvinyl chloride resin and a polyolefin resin, or may contain a polyvinyl chloride resin.

The outer sheath 12 contains one or more kinds selected from the polyvinyl chloride resin and the polyolefin resin, and thus the covered electric wire 11 included in the cable 10 can be protected while reducing the cost as compared with the case where a fluororesin or the like is used as the resin.

The polyvinyl chloride resin is a resin having excellent flame retardancy. Thus, the flame retardancy of the cable 10 can be increased by the outer sheath 12 containing the polyvinyl chloride resin.

The resin of the outer sheath 12 may be crosslinked or not crosslinked.

### (Additives)

The outer sheath 12 may contain additives such as a flame retardant, a flame retardant aid, an antioxidant, a lubricant, a coloring agent, a reflection-imparting agent, a masking agent, a processing stabilizer, and a plasticizer, in addition to the above-mentioned resins.

From the viewpoint of increasing the flame retardancy of the cable 10, the outer sheath 12 may contain a flame retardant. The flame retardant is not particularly limited, and for example, one or more kinds selected from magnesium hydroxide, aluminum hydroxide, antimony trioxide, and a bromine-based flame retardant can be used.

The flame retardancy of the cable 10 can be increased by the outer sheath 12 containing the flame retardant.

### (1-4) Shield Layer

As in a cable 20 shown in FIG. 2, the cable 20 may include a shield layer 14 disposed between a core 200 and the outer sheath 12. The shield layer 14 may include a conductive material.

### (Conductive Tape)

The shield layer 14 may include a conductive tape.

The shield layer 14 may be formed by, for example, spirally winding a conductive tape including a conductive layer along the longitudinal direction of the core 200.

The conductive tape may have only a conductive layer, or may have a laminated structure in which a conductive layer is disposed on one or more surfaces selected from the top surface and the bottom surface of the base material.

The material of the conductive layer is not particularly limited, and may include a metal, and may be, for example, a metal foil. When the conductive layer contains a metal, the material of the metal is not particularly limited, and for example, one or more kinds selected from copper, a copper alloy, aluminum, an aluminum alloy, and the like may be used.

The material of the base material is not particularly limited, and may include one or more kinds selected from insulating materials such as an organic polymer material and a nonwoven fabric. Examples of the organic polymer material include polyester resins such as polyethylene terephthalate (PET), polyolefin resins such as polypropylene, and vinyl resins such as polyvinyl chloride. The base material may be a base material containing an insulating material, or may be a base material made of only an insulating material.

When the shield layer 14 is formed by winding the conductive tape, the winding direction of the conductive tape is not particularly limited, and may be the same as or different from the twisting direction of the core 200, for example.

### (Metal Element Wire)

The shield layer 14 may include a metal element wire.

When the shield layer 14 includes the metal element wire, the shield layer 14 may be arranged so that the metal element wire has any structure selected from a braided structure and a spirally wound structure. The shield layer 14 includes the metal element wire which has any structure selected from the braided structure and the spirally wound structure, and thus, even when the cable 10 is repeatedly bent, the shield layer 14 can be suppressed from being broken or the like.

As a material of the metal element wire, one or more kinds selected from copper, aluminum, a copper alloy, and the like can be used. The metal element wire may be plated with silver or tin on the surface. Thus, for example, a silver-plated copper alloy, a tin-plated copper alloy, or the like can be used as the metal element wire. Since the cable has the shield layer, it is possible to reduce signal leakage to the outside and signal intrusion from the outside while increasing the bending resistance of the cable. The shield layer can also mechanically protect the core.

When the cable 20 includes the shield layer 14, the cable 20 may include a drain wire 15 so that a ground terminal of a device connected to an end of the cable 20 can be electrically connected to the shield layer 14. In the cable 20, the drain wire 15 may be disposed inside the core 200 so as to be electrically connected to the shield layer 14. The drain wire 15 may be twisted with the covered electric wire 11.

The drain wire 15 may have the same configuration as the covered electric wire 11 except that the insulator 112 is not provided and the conductor 111 is uncovered. Thus, the same material as the conductor 111 may be used as the material of the drain wire 15. The conductor of the drain wire 15 may be a single wire or a twisted wire formed by twisting a plurality of conductor element wires together.

### (1-5) Filler

The core 100 included in the cable 10 of the present embodiment may include a filler 13.

Since the core 100 includes the filler 13, the position of the covered electric wire 11 included in the cable 10 can be suppressed from being displaced when the cable 10 is repeatedly bent, and thus the bending resistance can be increased. In addition, in a cross section perpendicular to the longitudinal direction of the cable 10, the shape of the contour line of the core 100 can be made close to a circle, and the handleability of the cable 10 can be improved.

The filler 13 may be disposed so that the shape of the contour line of the core 100 can be made close to a circle in a cross section perpendicular to the longitudinal direction of the cable 10, for example. Thus, the filler 13 may be disposed in a region surrounded by the covered electric wires 11, as in the cable 10 shown in FIG. 1, for example, or may be disposed at a plurality of desired positions in the core 100 in a cross section perpendicular to the longitudinal direction of the cable 10.

The filler may include fibers such as staple fibers or nylon fibers. The filler may also include tensile strength fibers.

### (1-6) Suppression Wound Layer

The cable 10 may have a suppression wound layer between the core 100 and the outer sheath 12. The suppression wound layer may be formed by, for example, spirally winding a tape body along the longitudinal direction of the core 100. When the tape body is wound around the outer periphery of the core 100 to form the suppression wound layer, the winding direction of the tape body is not particularly limited, and may be the same as or different from the twisting direction of the core 100 described above, for example.

The tape body may include an insulating material such as paper, nonwoven fabric, or resin such as polyester.

By arranging the suppression wound layer between the core 100 and the outer sheath 12, the outer sheath 12 can be easily peeled off when the covered electric wire 11 is taken out at the end part along the longitudinal direction of the cable 10.

### EXAMPLES

The present disclosure will be described below with reference to specific examples, but the present invention is not limited to these examples.

### 1. Evaluation Method

First, an evaluation method for electric wires produced in the following experiments will be described.

### (1) Element Wire Diameter, Outer Diameter

The element wire diameter of the conductor element wire 111A (see FIG. 1) used for the conductor 111 was obtained by measuring the lengths of two orthogonal diameters in an arbitrary cross section perpendicular to the longitudinal direction of the conductor element wire 111A and calculating the average of the two diameters.

The outer diameter D111 of the conductor 111 was obtained by measuring the lengths of two orthogonal diameters of a minimum enclosing circle C111 of the conductor 111 in an arbitrary cross section perpendicular to the longitudinal direction of the cable 10 and calculating the average of the two diameters (see FIG. 1). The minimum enclosing circle means the smallest circle that encloses the target figure. Thus, the minimum enclosing circle C111 of the conductor 111 means the smallest circle that encloses the conductor 111 in the cross section to be evaluated.

An outer diameter D200 of the core 200 was obtained by measuring the lengths of two orthogonal diameters of a minimum enclosing circle C200 of the core 200 in an arbitrary cross section perpendicular to the longitudinal direction of the cable 20 and calculating the average of the two diameters.

(2) Twist pitch In the measurement of the twist pitch of the conductor 111 of the covered electric wire 11, the insulator 112 of the covered electric wire 11 was removed to expose the conductor 111. Next, the twist pitch of the conductor 111, that is, the twist pitch when the conductor element wires 111A included in the conductor 111 were twisted together was measured in accordance with JIS C 3005 (2014). Then, the magnification of the twist pitch of the conductor 111 with respect to the outer diameter D111 of the conductor 111 was calculated.

The twist pitch of the core 200 was measured by the same procedure as that for the twist pitch of the conductor 111 except that the measurement target was the core 200 and the twist pitch was set to a twist pitch when the covered electric wires 11 included in the core 200 were twisted together. Then, the magnification of the twist pitch of the core 200 with respect to the outer diameter D200 of the core 200 was calculated.

### (3) Tensile Elasticity Test

The insulator 112 included in the covered electric wire 11 was subjected to a tensile test in accordance with JIS K 7161 (2024) at a tensile speed of 500 mm/min and a gauge length of 50 mm by using a tensile tester.

### (4) Bending Resistance

The bending resistance test was performed according to the following procedure.

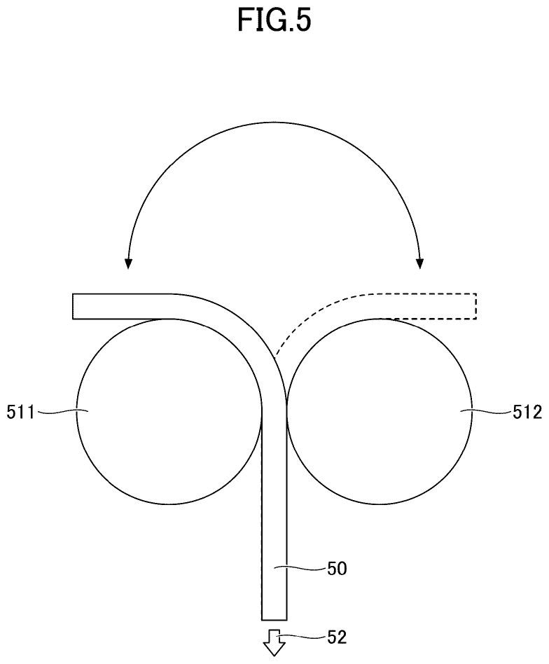

As shown in FIG. 5, a cable 50 to be evaluated is disposed in the vertical direction and sandwiched between two mandrels, a first mandrel 511 and a second mandrel 512, each having a diameter of 40 mm and disposed horizontally and parallel to each other. Then, the upper end of the cable 50 was bent by 90 degrees in the horizontal direction so as to abut on the upper side of the first mandrel 511, and then bent by 90 degrees in the horizontal direction so as to abut on the upper side of the second mandrel 512, and this operation was repeated. This repetition was performed while connecting the conductors of all the covered electric wires in the cable in series and measuring the resistance value, and the number of bending cycles when the resistance increased to greater than or equal to 10 times the initial resistance value before the start of the test was used as an index value of the bending resistance test. Regarding bending cycles evaluated in the bending resistance test, one cycle was defined as an operation of bending the cable 50 to the left side in FIG. 5, then bending the cable 50 to the right side, and finally returning the cable 50 to the left side. During the bending resistance test, a load of 5 N was applied to the cable 50 downward along a block arrow 52 in FIG. 5.

For the measurement, three samples were prepared for the same experiments and evaluated. The smallest number of bending cycles among the three samples was defined as the number of bending cycles in the bending resistance test for the sample of the experiments.

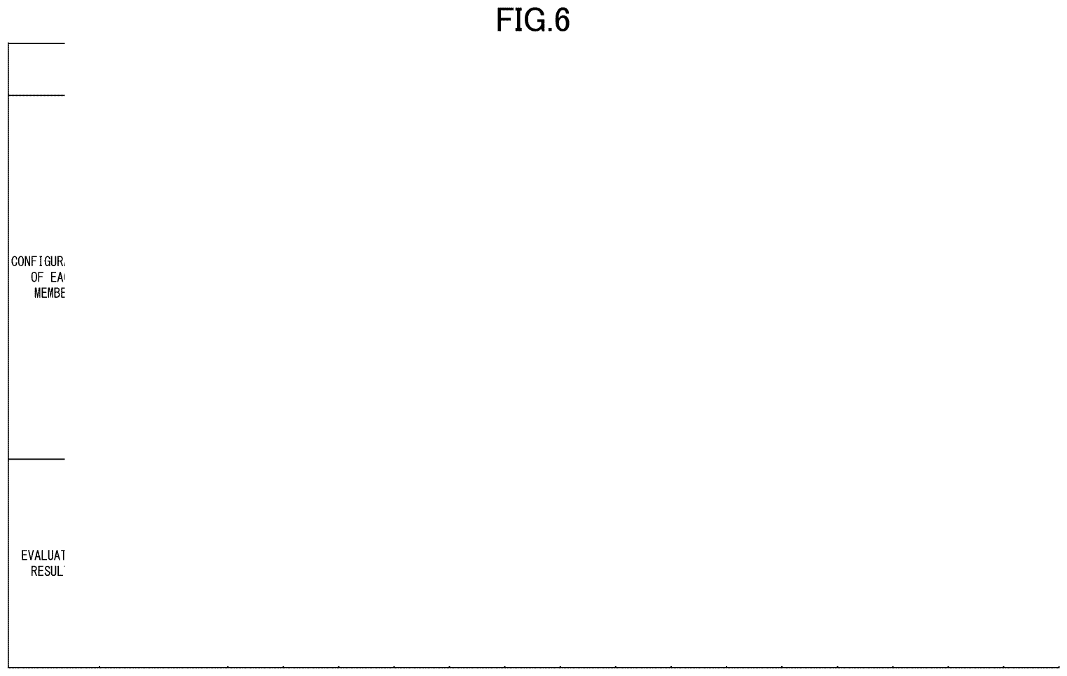

The evaluation was A when the index value of the bending resistance test, that is, the number of bending cycles was 1,000,000 times or more, B when the number bending cycles was 500,000 times or more and less than 1,000,000 times, C when the number of bending cycles was 250,000 times or more and less than 500,000 times, and D when the number of bending cycles was less than 250,000 times. The evaluation results are shown in the column of “Bending resistance” in FIG. 6.

The cable having the highest bending resistance is evaluated as A in the bending resistance test, and the bending resistance is decreased in the order of B, C, and D. When the evaluation of the bending resistance test is A or B, the cable can be evaluated as a cable having sufficient bending resistance. When the evaluation of the bending resistance test is C or D, the cable can be evaluated as a cable having insufficient bending resistance.

In the overall evaluation, the evaluation A was 2 points, the evaluation B was 1point, the evaluation C was−1 point, and the evaluation D was −2 points.

### (5) Flame Retardancy

The flame retardancy test was performed by a vertical flame test (VW-1) defined in the UL standard.

The vertical flame test (VW-1) is described in UL Standard 2556, and the following evaluation was performed on three samples produced under the same conditions.

A set of operations of flame contact for 15 seconds and flame separation for 15 seconds by the flame of the burner was repeated five times for each sample arranged so that the longitudinal direction of the cable was vertical. A sample is regarded as good when the following conditions are satisfied. When a set of operations of flame contact and flame separation is repeated five times, it is extinguished within 60 seconds, the absorbent cotton laid on the lower part is not burnt by the combustion falling object, and the craft paper attached to the upper part of the sample is not burnt or scorched. The three samples were evaluated. A case where all of the three samples were good was evaluated as A, a case where any one or two samples were not good was evaluated as B, and a case where all of the three samples were not good was evaluated as C. The evaluation result is shown in the column of “Flame retardancy” in FIG. 6.

The cable evaluated as A is considered to be excellent in flame retardancy. The cable evaluated as B is considered to be inferior in flame retardancy, and the cable evaluated as C is considered to be even more inferior in flame retardancy.

In the overall evaluation, the evaluation A was 2 points, the evaluation B was 1 point, and the evaluation C was 0 points.

### (6) Bending Resistance of Shield Layer

After the bending resistance test was completed, the outer sheath 12 was removed, and the state of the shield layer 14 was visually checked. A case where no fracture was observed in the metal element wire or the metal foil included in the shield layer 14 was evaluated as A, and a case where the metal element wire or the metal foil included in the shield layer 14 was fractured and included a discontinuous part was evaluated as B. The evaluation results are shown in the column of “Bending resistance of shield layer” in FIG. 6.

The cable evaluated as A is considered to be excellent in the bending resistance of the shield layer. The cable evaluated as B is considered to be inferior in bending resistance of the shield layer.

In the overall evaluation, the evaluation A was 2 points, and the evaluation B was 0 points.

### (7) Overall Evaluation

The scores based on the evaluation were added for the bending resistance, flame retardancy, and bending resistance of the shield layer.

When the overall evaluation is 2 points or more, the cable can be evaluated as an overall excellent cable.

### 2. Cable Production Conditions

The cable in each experiment will be described below.

Experiments 1 to 7 are examples. Experiments 8 to 15 are comparative examples.

### (Experiment 1)

The cable 20 having a cross-sectional structure shown in FIG. 2 was produced and evaluated.

### (1) Covered Electric Wire

The conductor 111 of the covered electric wire 11 included in the cable 20 is formed by twisting 40 wires having an element wire diameter of 0.08 mm, and the conductor cross-sectional area is 0.20 mm². As a material of the conductor 111, a copper-tin alloy containing tin at a ratio of 0.3 mass % was used. FIG. 6 denotes conductor 111 as “Copper alloy” when the copper-tin alloy was used as the material of the conductor 111.

The twist pitch of the conductor 111 was 21 times the outer diameter D111 of the conductor 111, as shown in the column “Twist pitch” in FIG. 6.

As shown in the column of “Resin” in FIG. 6, the insulator 112 was made of a material containing polyvinyl chloride resin (PVC) as a resin, and having the tensile modulus shown in FIG. 6.

Two of the covered electric wires 11 are twisted together to form the twisted-pair electric wire 101, and then twisted together with the other covered electric wires 11 and the drain wire 15 to form the core 200. The twist pitch of the core 200 was about 10 times the outer diameter D200 of the core 200.

Outside the core 200, the shield layer 14 and the outer sheath 12 were disposed in this order from the position close to the core 200.

### (2) Shield Layer

The shield layer was formed by spirally winding a conductive tape, in which an aluminum foil was disposed on a polyethylene terephthalate (PET) base material, along the longitudinal direction of the core 200. The shield layer is indicated as “Al metal foil” in FIG. 6.

### (3) Outer Sheath

The outer sheath 12 contains a polyvinyl chloride resin as a resin as shown in the column of “Resin” in FIG. 6. A material containing a flame retardant is used for the outer sheath 12. “Present” in the column of “Flame retardant” in FIG. 6 denotes the outer sheath 12 contained a flame retardant.

The evaluation results are shown in FIG. 6.

### (Experiment 2)

A cable was produced under the same conditions as in Experiment 1, except that the amount of plasticizer added to the insulator 112 was changed to set the tensile modulus to the value shown in FIG. 6, and evaluated. The evaluation results are shown in FIG. 6.

### (Experiment 3)

A cable was produced under the same conditions as in Experiment 2 except that the shield layer 14 was a shield layer having a braided structure of metal element wires made of the same copper alloy as the conductor 111, and evaluated.

The shield layer is indicated as “Metal element wire” in FIG. 6. The evaluation results are shown in FIG. 6.

### (Experiment 4)

A cable was produced under the same conditions as in Experiment 2 except that the twist pitch of the conductor 111 was changed, and evaluated. The evaluation results are shown in FIG. 6.

### (Experiment 5)

A cable was produced under the same conditions as in Experiment 4, except that the shield layer 14 was a shield layer having a braided structure of metal element wires made of the same copper alloy as the conductor 111, and evaluated.

### (Experiment 6)

A cable was produced under the same conditions as in Experiment 2 except that the twist pitch of the conductor 111 was changed, and evaluated. The evaluation results are shown in FIG. 6.

### (Experiment 7)

A cable was produced under the same conditions as in Experiment 2 except that polyethylene resin (PE) was used as the resin for the outer sheath 12 instead of polyvinyl chloride, and evaluated. The evaluation results are shown in FIG. 6.

### (Experiment 8)

The tensile modulus was set to the value shown in FIG. 6 by changing the amount of the plasticizer added to the insulator 112. No flame retardant was added to the outer sheath 12. Except for the above points, the cable was produced under the same conditions as in Experiment 1, and evaluated. The evaluation results are shown in FIG. 6.

A hyphen “-” in the column of “Flame retardant” in FIG. 6 denotes the outer sheath 12 did not contain a flame retardant.

### (Experiment 9)

A cable was produced under the same conditions as in Experiment 1, except that the amount of plasticizer added to the insulator 112 was changed to set the tensile modulus to the value shown in FIG. 6, and evaluated. The evaluation results are shown in FIG. 6.

### (Experiment 10)

A cable was produced under the same conditions as in Experiment 1, except that the amount of plasticizer added to the insulator 112 was changed to set the tensile modulus to the value shown in FIG. 6, and evaluated. The evaluation results are shown in FIG. 6.

### (Experiment 11)

A cable was produced under the same conditions as in Experiment 2 except that the twist pitch of the conductor 111 was changed, and evaluated. The evaluation results are shown in FIG. 6.

### (Experiment 12)

Annealed copper was used as the material of the conductor 111, and the twist pitch of the conductor 111 was set to 18 times the outer diameter D111 of the conductor 111. No flame retardant was added to the outer sheath 12. Except for the above points, a cable was produced under the same conditions as in Experiment 2, and evaluated. The evaluation results are shown in FIG. 6.

### (Experiment 13)

Annealed copper was used as the material of the conductor 111, and the twist pitch of the conductor 111 was set to 18 times the outer diameter D111 of the conductor 111. Except for the above point, a cable was produced under the same conditions as in Experiment 2, and evaluated. The evaluation results are shown in FIG. 6.

### (Experiment 14)

For the outer sheath 12, polyethylene resin (PE) was used instead of polyvinyl chloride as the resin. The tensile modulus was set to the value shown in FIG. 6 by changing the amount of the plasticizer added to the insulator 112. No flame retardant was added to the outer sheath 12. Except for the above points, a cable was produced under the same conditions as in Experiment 1, and evaluated. The evaluation results are shown in FIG. 6.

### (Experiment 15)

For the outer sheath 12, polyethylene resin (PE) was used instead of polyvinyl chloride as the resin. The tensile modulus was set to the value shown in FIG. 6 by changing the amount of the plasticizer added to the insulator 112. Except for the above points, a cable was produced under the same conditions as in Experiment 1, and evaluated. The evaluation results are shown in FIG. 6.

According to the results shown in FIG. 6, it has been confirmed that the cables of Experiments 1 to 7, in which the twist pitch of the conductor 111 is less than or equal to 25 times the outer diameter D111 of the conductor 111, the insulator 112 contains polyvinylchloride, and the tensile modulus is 150 MPa or more, have excellent bending resistance.

In contrast, in the cables of Experiments 8 to 10, 14, and 15, the tensile modulus of the insulator 112 is less than 150 MPa. In the cable of Experiment 11, the twist pitch of the conductor 111 is larger than 25 times the outer diameter D111 of the conductor 111. In the cables of Experiments 12 and 13, annealed copper is used as the material of the conductor. Thus, it has been confirmed that the cables of Experiments 8 to 15, which are evaluated as C or D in bending resistance, are inferior in bending resistance.

Furthermore, it has been confirmed that the cables of Experiments 8 to 15 have lower overall evaluation than the cables of Experiments 1 to 7.

What is claimed is:

1. A cable comprising:
a core including at least one covered electric wire; and
an outer sheath disposed outside the core,
wherein the at least one covered electric wire includes a conductor made of a copper alloy and an insulator disposed outside the conductor,
wherein the conductor is a twisted wire formed by twisting a plurality of conductor element wires together, and a twist pitch of the conductor is less than or equal to 25 times an outer diameter of the conductor, and
wherein the insulator contains a polyvinyl chloride resin and has a tensile modulus of 150 MPa or more.

2. The cable according to claim 1,
wherein the core includes a plurality of the covered electric wires, and
wherein the plurality of covered electric wires are twisted together along a longitudinal direction of the plurality of covered electric wires.

3. The cable according to claim 1, further comprising:
a shield layer disposed between the core and the outer sheath.

4. The cable according to claim 1,
wherein the copper alloy is a copper-tin alloy.

5. The cable according to claim 1,
wherein the outer sheath contains a polyvinyl chloride resin.

6. The cable according to claim 1,
wherein the outer sheath contains a flame retardant.

7. The cable according to claim 1,
wherein the core includes a twisted-pair electric wire formed of two covered electric wires twisted together, each of the two covered electric wires being the at least one covered electric wire.

8. The cable according to claim 1,
wherein the core includes a filler.
